(19) United States
(12) Patent Application Publication
(10) Pub. No.: US 2003/0101770 A1
(43) Pub. Date: Jun. 5, 2003

(54) Method and system for producing deposit of fine glass particles

(76) Inventors: Motonori Nakamura, Kanagawa (JP); Toshihiro Ooishi, Kanagawa (JP); Yuichi Ohga, Kanagawa (JP)

Correspondence Address: MCDERMOTT WILL & EMERY, 600 13TH STREET, N.W., WASHINGTON, DC, 20005-3096, US

(21) Appl. No.: 10/275,486

(22) PCT Filed: Mar. 6, 2002
(86) PCT No.: PCT/JP02/02058

(30) Foreign Application Priority Data
Mar. 6, 2001 (JP) 2001-62091
Feb. 15, 2002 (JP) 2002-38080

(51) Int. Cl. C03B 37/07; C03B 37/018

(52) U.S. Cl. 65/382; 65/421

(57) ABSTRACT

An object of the present invention is to provide a method and apparatus for producing a glass particles deposit in which a soot body having less fluctuation in the outer diameter in a longitudinal direction can be produced without increasing an ineffective portion formed at an end portion of the soot body.

The invention relates to the method and apparatus for producing the glass particles deposit, in which a starting rod 1 is supported by a rotatable supporting rod 3 and disposed within a reaction vessel 4 having an exhaust port 5. A burner array 8 is composed of odd numbered burners 6 and even numbered burners 7. The odd numbered burners 6 and the even numbered burners 7 are set to have different synthesis conditions for glass particles. Glass particles synthesized by the burners are deposited on the starting rod 1 while rotating the starting rod 1, thereby producing the glass particles deposit 9.

### TECHNICAL FIELD

The present invention relates to a method and apparatus for producing a glass particles deposit by an OVD method.

### BACKGROUND TECHNIQUE

One of the methods for producing a glass particles deposit for an optical fiber preform is a method (OVD method) in which glass particles (hereinafter referred to as “soot”) synthesized by glass particle synthesizing burners are deposited in layers on a rotating starting rod.

To obtain an optical fiber preform of good quality, it is important to reduce the fluctuation in the outer diameter of the glass particles deposit (hereinafter referred to a “soot body”) in the length direction to the minimum. From the aspect of productivity, it is required to have a high deposition rate and a high deposition efficiency, for which various methods have been offered.

For example, in Japanese Patent Unexamined Publication No. Sho. 53-70499, there was disclosed a method for producing a preform for optical communication in which the perform uniformly doped with dopant in the radial direction can be obtained. This method involves depositing glass particles synthesized by a plurality of oxyhydrogen burners on a core glass rod, in which the burners are arranged transversely in one row to have an almost equal length to that of the core glass rod to form a burner array.

Another producing method involves a plurality of burners arranged at regular intervals to be opposed to the core glass rod. This method involves depositing glass particles on the glass rod, while moving the glass rod and the burners relatively and in parallel.

A still other producing method involves reciprocating the glass rod and the burners relatively while shifting a turn-back point of reciprocating movement, in which the turn-back point of reciprocating movement is shifted up to a predetermined position, and then shifted in a reverse direction to an initial position, as disclosed in Japanese Patent Unexamined Publication No. Hei. 3-228845. With this method, the turn-back points at which it takes a substantially longer sooting time are dispersed over the entire soot body, whereby the substantial sooting time for the entire soot body or fluctuation of the degree of touching of a burner flame against the soot body can be made uniform in average over the total length of the glass particles deposit to equalize the deposit amount of soot at each point of the glass particles deposit and reduce the fluctuation in the outer diameter.

### DISCLOSURE OF THE INVENTION

It is an object of the present invention to provide a method and apparatus for producing a glass particles deposit in which there are less fluctuation in the outer diameter in a longitudinal direction without increasing an ineffective portion formed at an end portion of a soot body.

The method for producing the glass particles deposit according to the invention in which a plurality of glass particle synthesizing burners are arranged to be opposed to a rotating starting rod, and glass particles synthesized by the glass particle synthesizing burners are deposited on the surface of the starting rod to produce the glass particles deposit, wherein three or more glass particle synthesizing burners are arranged in a state that each interval between burners is adjusted, and glass particle synthesis conditions for odd numbered burners located at the odd number when counted from one end of the burners, and those for even numbered burners located at the even number are set up differently, whereby glass particles are deposited on the surface of the starting rod to produce the glass particles deposit with less fluctuation in the outer diameter in the longitudinal direction.

In the producing method of this invention, a total number of glass particle synthesizing burners is preferably odd.

The producing method of this invention preferably includes setting up an interval L between burners in a group of burners having a greater flow rate of raw material per burner, which group is selected from a group of burners located at the odd number when counted from one end and a group of burners located at the even number in the glass particle synthesizing burners to satisfy the following formula (1), and arranging the burners in a group of burners having a smaller flow rate of raw material per burner at an interval of L/2 to the adjacent burners in another group of burners.

10a≦L≦A (1)

In the formula (1), L is a burner-to-burner interval (mm) for the group of burners having greater flow rate of raw material per burner, a is flow rate of raw material (liter/min) of a burner having the greatest flow rate of raw material÷22.4 (liters/mole)×60 (g/mole), and A is an outer diameter (mm) of glass particles deposit of target.

The producing method of this invention preferably has a deviation of burner-to-burner interval from a set value in a range from +10% to −10% of the set value.

The producing method of this invention includes setting up the glass particle synthesis conditions in the glass particle synthesizing burners so that the amount of gas supplied to each burner is alternately different.

The producing method of this invention preferably includes setting up the glass particle synthesis conditions in the glass particle synthesizing burners so that the structure of each burner is alternately different.

An apparatus for producing a glass particles deposit according to the invention in which a plurality of glass particle synthesizing burners are arranged to be opposed to a rotating starting rod, and glass particles synthesized by the glass particle synthesizing burners are deposited on the surface of the starting rod to produce the glass particles deposit, wherein three or more glass particle synthesizing burners are arranged in a state that each interval between burners is adjusted at a predetermined value, and a structure of odd numbered burners located at the odd number when counted from one end of the burners, and a structure of even numbered burners located at the even number are set up differently, thereby producing the glass particles deposit with less fluctuation in the outer diameter in the longitudinal direction.

In the producing apparatus of this invention, a total number of three or more glass particle synthesizing burners is preferably odd.

The producing apparatus of this invention preferably the burners is divided into two rows, when both rows of burners are seen as one array of burners from a direction perpendicular to the row of burners, burners located at the odd number when counted from one end are arranged in one row, and burners located at the even number are arranged in the other row.

### BRIEF DESCRIPTION OF THE DRAWINGS

FIG. 1 is an explanatory view exemplarily illustrating one example of an apparatus constitution for practicing the present invention.

FIG. 2 shows a deposited state of soot on the starting rod when there is a small interval between the odd numbered burners, (a) is an exemplary view showing a burner array, (b) is an exemplary view of a soot body that is deposited only by the odd numbered burners, (c) is an exemplary view of the soot body that is deposited only by the even numbered burners, and (d) is an exemplary view of the soot body when there is no compensation for the fluctuation in the outer diameter of the soot body.

FIG. 3 shows a deposited state of soot on the starting rod when there is a large interval between the odd numbered burners, (a) is an exemplary view showing a burner array, (b) is an exemplary view of a soot body that is deposited only by the odd numbered burners, (c) is an exemplary view of the soot body that is deposited only by the even numbered burners, and (d) is an exemplary view of the soot body when there is no compensation for the fluctuation in the outer diameter of the soot body.

FIG. 4 shows how to arrange the burners, (a) is an exemplary view showing the burners arranged as one row on the same line, (b) is an exemplary view showing two rows of burners arranged at a desired angle θ, and (c) is an exemplary view showing two rows of burners arranged in parallel.

FIG. 5 shows a deposited state of a soot body by the method of the invention, (a) is an exemplary view showing a burner array, (b) is an exemplary view of the soot body that is deposited only by the odd numbered burners, (c) is an exemplary view of the soot body that is deposited only by the even numbered burners, and (d) is an exemplary view of the soot body that is deposited by the odd numbered burners and the even numbered burners.

FIG. 6 shows a deposited state of a soot body by another method of the invention, (a) is an exemplary view of the soot body that is deposited only by the even numbered burners, (b) is an exemplary view of the soot body that is deposited only by the odd numbered burners, and (c) is an exemplary view of the soot body that is deposited by the odd numbered burners and the even numbered burners.

FIG. 7 is a graph showing the outer diameter fluctuation ratio of the soot body obtained when the positions of the burners in the example 6 are shifted from the set positions.

FIG. 8 is an exemplary view showing a conventional example of the method for producing the glass particles deposit.

In these figures, 1 is a starting rod, 2 is an effective portion, 3 is a supporting rod, 4 is a reaction vessel, 5 is an exhaust port, 6 is an odd numbered burner, 7 is an even numbered burner, 8 is a burner array, 9 is a soot body, 10 is a clean air introducing unit, 11 is a rod holding portion, 12 is a rotation unit, 13, 14 and 15 are a deposited soot, 16 is a burner, 17, 18 and 19 are burner arrays, and 20, 21 and 22 are burners.

### BEST MODE FOR CARRYING OUT THE INVENTION

A basic idea for the inventive method is that in a method for producing the glass particles deposit, a plurality of glass particle synthesizing burners are arranged to be opposed to a rotating starting rod, and glass particles synthesized by the glass particle synthesizing burners are deposited on the surface of a starting rod, the starting rod and the glass particle synthesizing burners are not reciprocated, a burner-to-burner interval is adjusted, and the amount of raw material gas, combustible gas, combustion support gas, and seal gas to be supplied to the burners is adjusted, or the specification of the burners is altered to reduce the fluctuation in the outer diameter in the longitudinal direction that is problematical with this method, and to make an non-effective portion at both ends relatively small.

This invention will be described below with reference to the drawings.

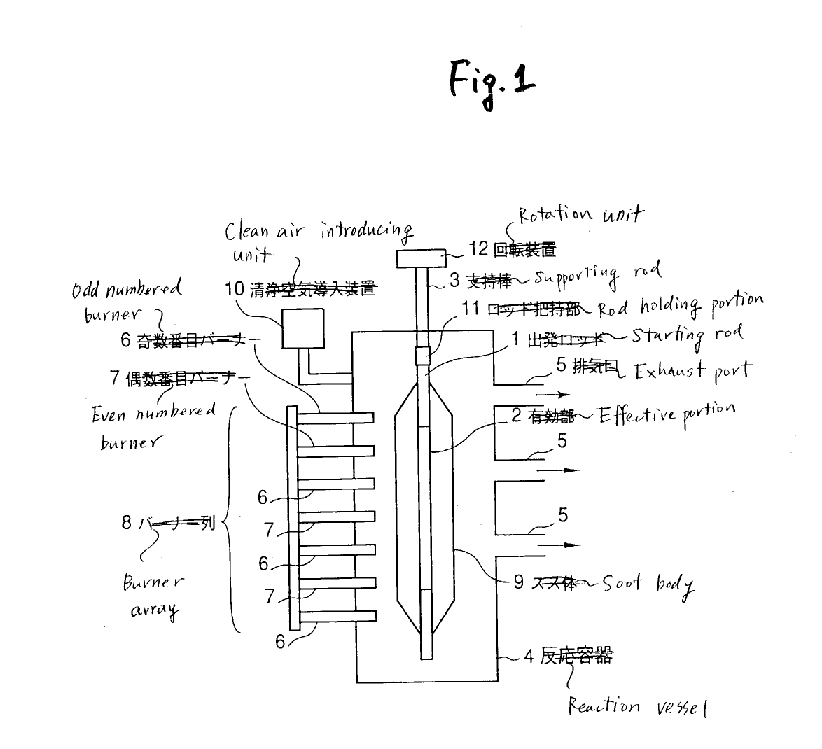

In FIG. 1, a starting rod 1 is supported by a rotatable supporting rod 3, and disposed within a reaction vessel 4 having the exhaust ports 5. In this example, a burner array 8 consists of a total of seven burners including four odd numbered burners 6 and three even numbered burners 7. The odd numbered burners 6 and the even numbered burners 7 are set up to have different conditions for synthesizing the glass particles. The burner array 8 is opposed to the starting rod 1. The length between one end odd numbered burner 6 and the other end odd numbered burner 6 is set up to be greater than the length of an effective portion 2 of the starting rod 1.

Each burner blows out a raw material gas such as SiCl₄, a combustible gas such as hydrogen, a combustion support gas such as oxygen, or a seal gas such as argon gas to form a flame. A soot body 9 is produced by depositing glass particles synthesized by the formed flame onto the starting rod 1 while rotating the starting rod 1.

The clean air is introduced from a clean air introducing unit 10 into the reaction vessel 4. The starting rod 1 is held by a rod holding portion 11 and rotated by a rotation unit 12.

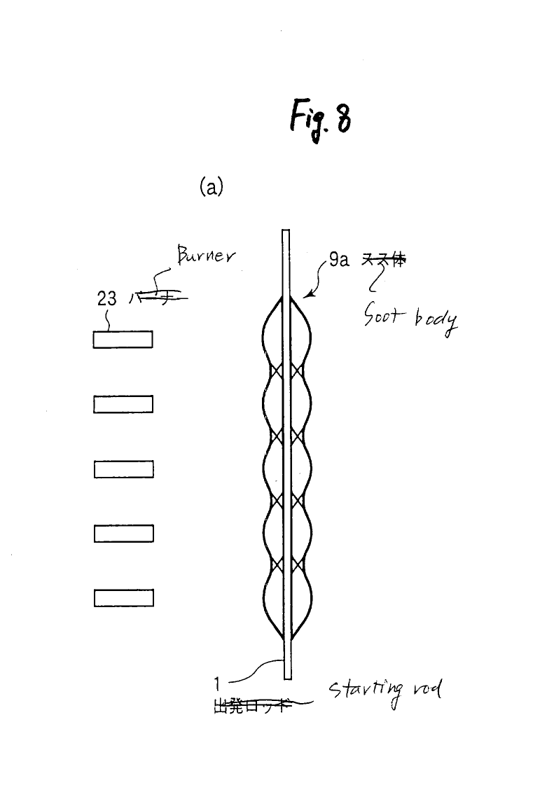

In the producing method of the conventional example as shown in FIG. 8, a plurality of glass particle synthesizing burners 23 are arranged to be opposed to the rotating starting rod. The soot body 9 is produced by depositing the soot synthesized by the burners 16 on the surface of the starting rod 1 without moving the starting rod 1 and the burners 16 relatively. To equalize the glass particles synthesis conditions as much as possible, the burners 16 are arranged at regular intervals where flames of adjacent burners do not interfere. Therefore, each burner 16 has a high soot deposition rate near the center of burner, but a slow growth of soot body and a low soot synthesis yield in the periphery of burner. Due to a difference in the soot synthesis yield, the outer diameter of soot body was fluctuated in the longitudinal direction, and the quality was degraded.

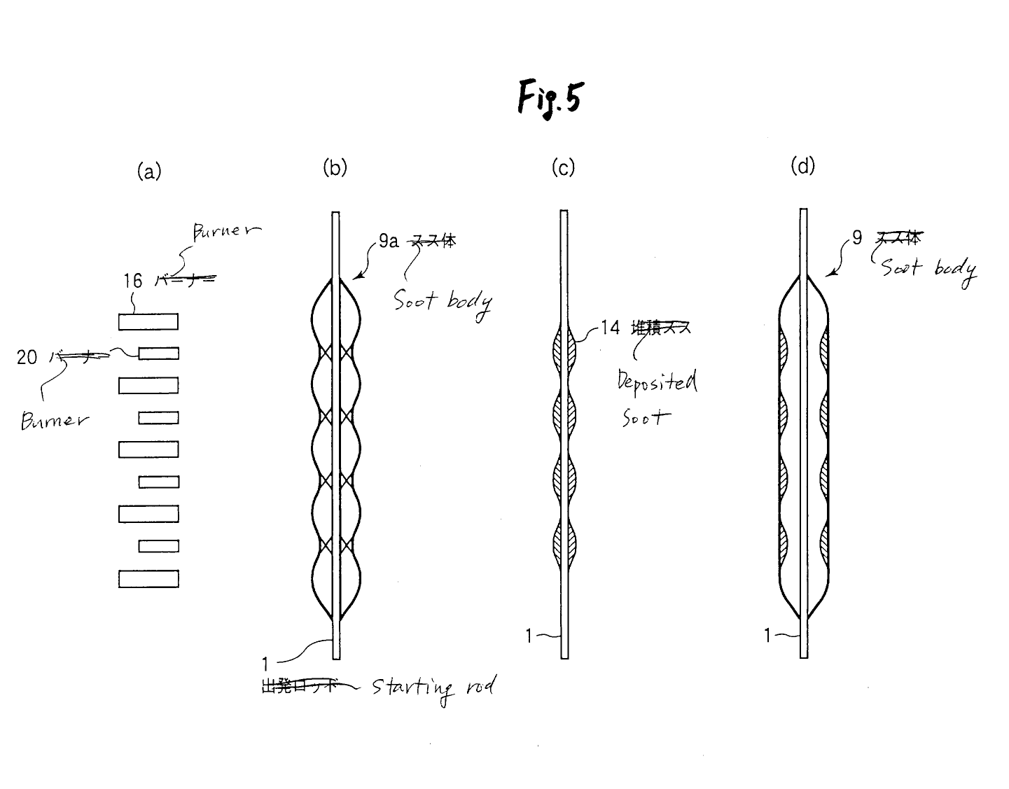

On the contrary, in this embodiment, the soot synthesis conditions can be adjusted for each burner by regulating the amount of gas supplied to the burner and changing the structure of burner alternately. By properly adjusting the soot synthesis conditions and the interval of each burner, the fluctuation in the outer diameter of soot body in the longitudinal direction are reduced to make an even shape. For example, the burners 20 that have different synthesis conditions from the burners 16 are arranged between the burners 16, as shown in FIG. 5(a). The soot synthesized by the burners 16 is deposited on the starting rod to form a soot body 9a, as shown in FIG. 5(b). In the case where the soot is synthesized only by the burners 20, as shown in FIG. 5(c), the soot body 14 is formed on the starting rod. By adjusting the interval between each burner and the synthesis conditions, the fluctuation in the outer diameter of the soot body 9 formed by the burners 16 can be complemented by the soot synthesized by the burners 20. By synthesizing the soot by the burners 16 and 20, the soot body 9 having almost uniform outer diameter and good shape is obtained, shown in FIG. 5(d). Three or more glass particle synthesizing burners are arranged, and the soot synthesis conditions for the burners are the same for the odd numbered burners (burners 16 in FIG. 5(a)) when counted from the end of the burner array and for the even numbered burners (burners 20 in FIG. 5(a)). Or the soot synthesis conditions for the odd numbered burners and the even numbered burners are set up differently, and the interval between burners is appropriately set up in accordance with the soot synthesis conditions. In the case where the number of burners is odd, the soot body having symmetrical ends is produced.

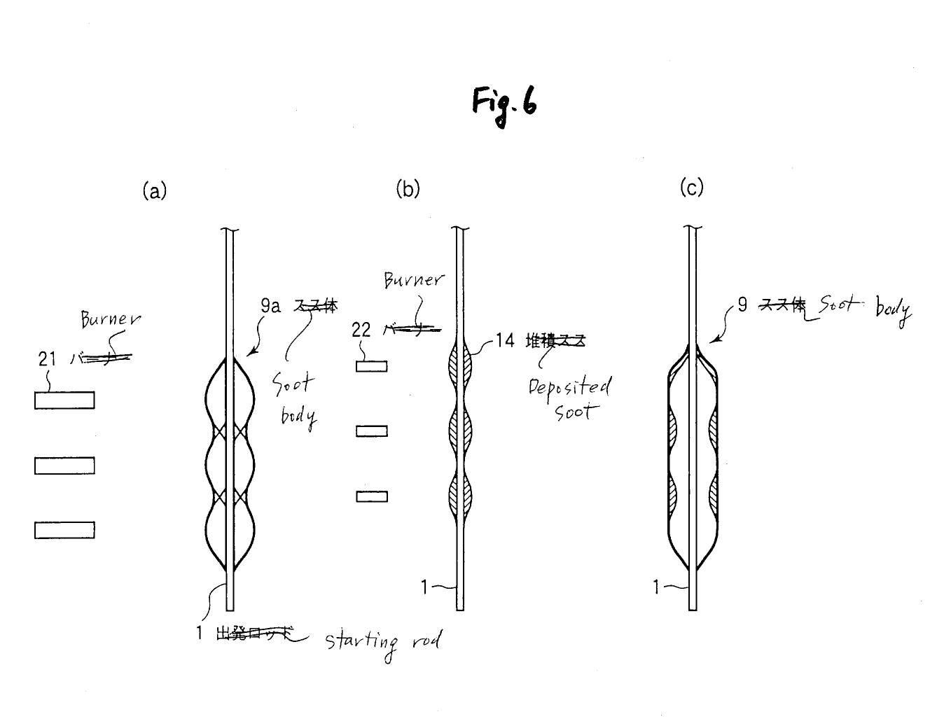

In the case where the number of burners is even, the shapes of soot body at both ends are unsymmetrical, but the soot body has less fluctuation in the outer diameter as a whole, in which there is also the above effect. As shown in FIG. 6, three burners 21 located at the odd number when counted from one end (lower end in the example as shown in FIG. 6(a)), and three burners 22 located at the even number (as shown in FIG. 6(b)) are combined to have an even number of burners. By adjusting each interval between burners and the synthesis conditions, the fluctuation in the outer diameter of the soot body 9a synthesized by the burners 21 are compensated by the deposited soot 14 synthesized by the burners 22. With the even number of burners 21 and 22, the soot body 9 having almost same outer diameter and good shape can be obtained, as shown in FIG. 6(c).

A specific example of burner interval, the interval between burners in a group of burners having a greater flow rate of raw material per burner which is selected from the burners located at the odd number from one end or the burners located at the even number is set to satisfy the following formula (1)

10a≦L≦A (1)

In the formula (1), L is the interval (mm) between burners in the group of burners having greater flow rate of raw material per burner, a is a flow rate of raw material (liter/min) of a burner having the greatest flow rate of raw material÷22.4 (liter/mole)×60 (g/mole), and A is an outer diameter (mm) of glass particles deposit of target.

The burners in the group of burners having smaller flow rate of raw materials per burner should be arranged at an interval of L/2 to the adjacent burners in the group of burners having greater flow rate of raw material per burner.

In the case where the number of burners is even, the burners at the odd number and the even number may be different depending on from which end the burners are numbered. However, in this embodiment, the burners are numbered from the end at which the burner having greater flow rate of raw material is disposed. That is, in the case where the number of burners is even, the group of burners at the odd number is the group of burners having greater flow rate of raw material, and the group of burners at the even number is the group of burners having smaller flow rate of raw material.

When the flow rate of raw material is increased to some extent, degree of interference between the even numbered burner and the odd numbered burner increases, namely, between adjacent burners, if the interval between burners is narrow. If degree of interference between burners increases, the outer diameter of soot body and the shape of soot deposited face are unstable, whereby the effect of the invention can not be attained. To accomplish the effect of the invention, the interval L between burners having a greater flow rate of raw material is made 10a (mm) or greater.

In the formula 1, if L is greater than the outer diameter of glass particles deposit of target, an area where one burner having greater flow rate of raw material deposits the soot is too farther away from that of the other burner. Hence, the burners having smaller flow rate of raw material can not compensate for the deposited soot. The burners having smaller flow rate of raw material, including that located most outside, are desirably arranged at an interval of L/2 to the adjacent burners having greater flow rate of raw material.

It is unnecessary that the interval between burners is strictly L/2, and it is only necessary that the burner position practically falls within a range of +10% to −10% from the set value of L/2. Within this range, the fluctuation ratio of outer diameter for the soot body can be reduced within 5%. If the deviation in the burner interval exceeds the range of +10% to −10%, the fluctuation ratio of outer diameter for the soot body is unpreferably increased.

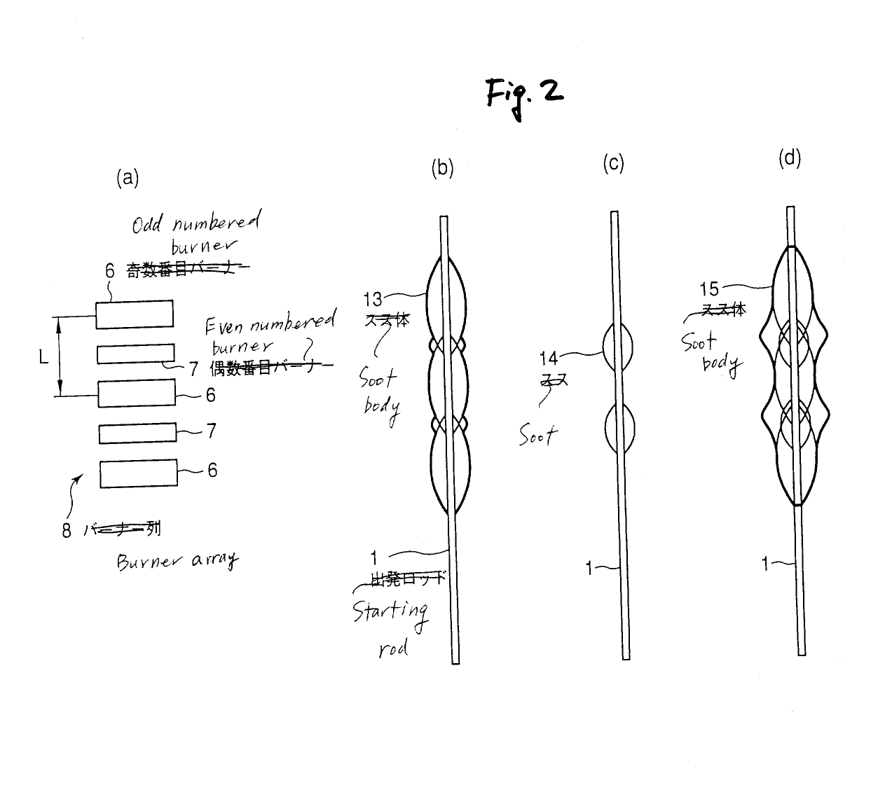

FIG. 2 exemplarily shows a soot deposited state in the case where the interval L between burners having greater flow rate of raw material is less than the flow rate of raw material (a×22.4÷60), with 10a>L, and the formula (1) is not satisfied. In this example, the odd numbered burners are burners having greater flow rate of raw material in the burner array 8 as shown in FIG. 2(a). Only with the odd numbered burners 6, there occurs the interference between burners, so that the outer diameter of the soot body 13 is unstable, as shown in FIG. 2(b). The soot 14 deposited on the starting rod only by the even numbered burners 7 is shown in FIG. 2(c). The soot 14 can not compensate for the fluctuation in the outer diameter of the soot body 13, and the outer diameter of the soot body 15 is fluctuated, as shown in FIG. 2(d).

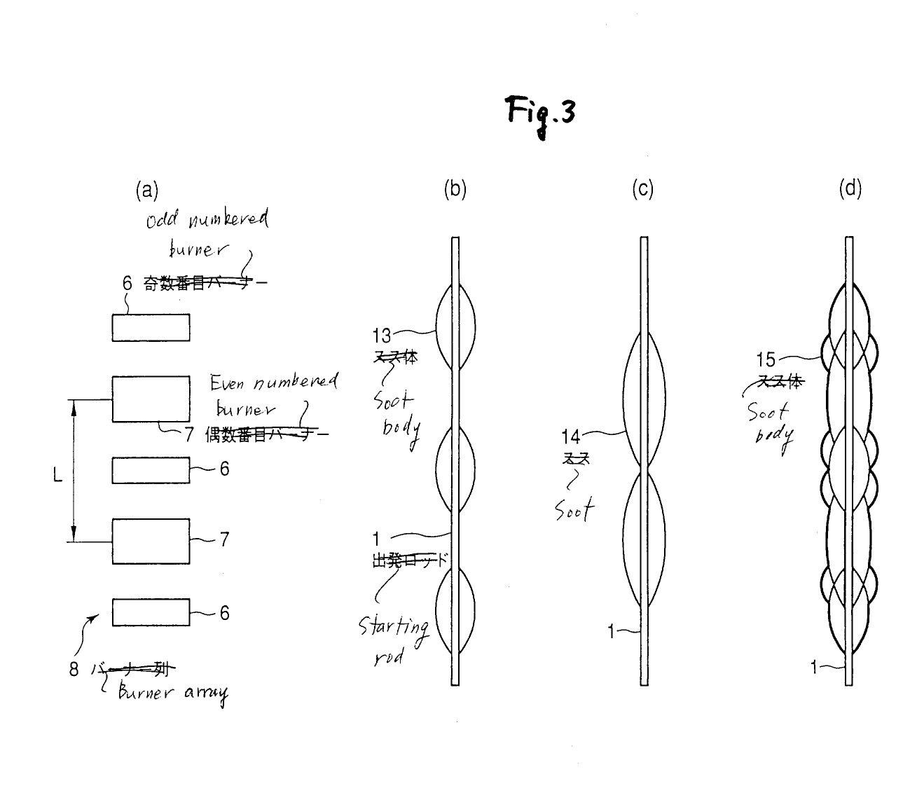

FIG. 3 exemplarily shows a soot deposited state in the case where the interval L between burners having greater flow rate of raw material is more than the outer diameter A of soot body, with L>A, and the formula (1) is not satisfied. In this example, the even numbered burners are burners having greater flow rate of raw material in the burner array 8 as shown in FIG. 3(a). The soot 13 deposited on the starting rod only by the odd numbered burners 6 is shown in FIG. 3(b). There is no interference between even numbered burners, so that the soot body 14 deposited on the starting rod 1 is not overlapped, as shown in FIG. 3(c). However, since L is too large as compared with the outer diameter of the soot body 14, the soot 13 can not compensate for the fluctuation in the outer diameter of the soot body 14, whereby the outer diameter of the soot body 15 is fluctuated, as shown in FIG. 3(d).

Conventionally, the glass particle synthesis conditions for five burners were all the same. In this case, the fluctuation in the outer diameter of soot body are larger than the fluctuation in the outer diameter of the soot body as shown in FIGS. 2 and 3. This invention allows the fluctuation in the outer diameter of soot body to be smaller than those by the conventional method.

In the case where the burners having the same soot synthesis conditions are used, there often occur fluctuation in the outer diameter as large as 10 to 20% in the longitudinal direction of the soot body, with the optimal interval between burners. To compensate for the fluctuation in the outer diameter, with the method of this invention, the burners having smaller flow rate of raw material are placed between the burners having greater flow rate of raw material, and the interval between burners having greater flow rate of raw material is adjusted, as needed, whereby the soot is synthesized. The number of burners maybe even, and a burner having smaller flow rate of raw material may be disposed outside one end of the group of burners having greater flow rate of raw material.

A raw material gas, a combustible gas, a combustion support gas and a seal gas are supplied to each burner. The burners having smaller flow rate of raw material are required to have at least about 10% of the flow rate of raw material for the burners having greater flow rate of raw material, and in consideration of a lower yield due to interference between flames, the conditions are appropriately set up to have more about 10% of the flow rate. If the soot bulk density is too high or low, the soot body is cracked, or shrunk unevenly in the longitudinal direction during the sintering process. Therefore, it is preferable that the bulk density is almost constant by setting the flow rate of H₂ or O₂ so that the temperature of the soot deposited face is almost uniform over the entire soot body. The flow rate of seal gas has a relatively slight effect.

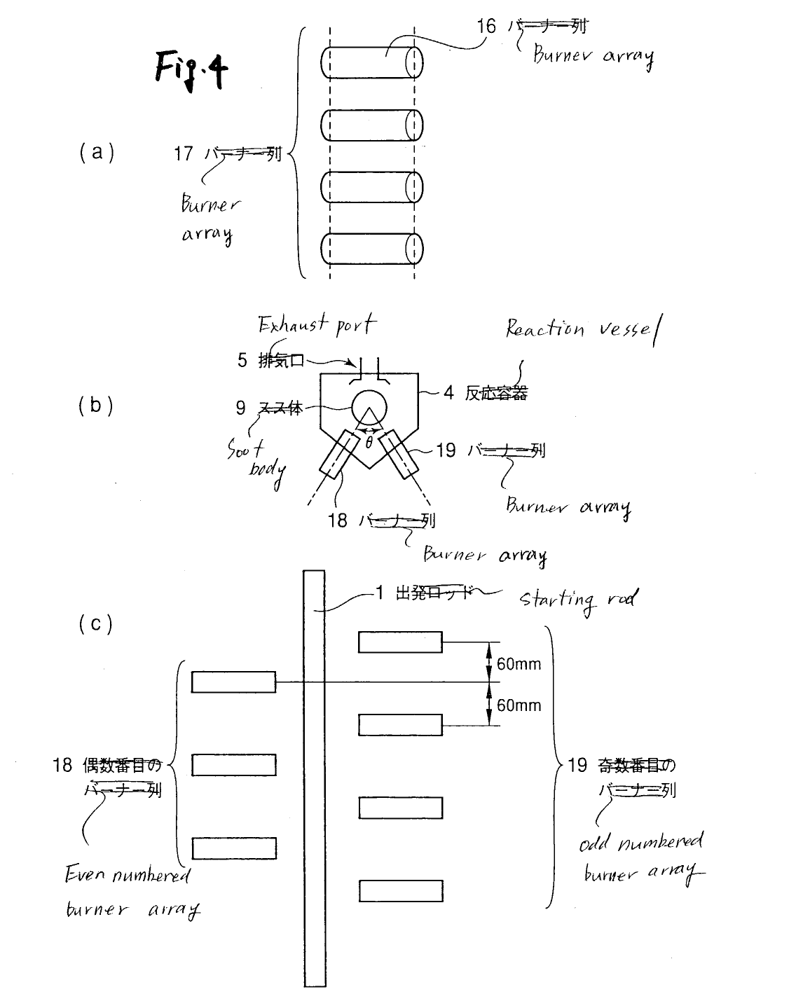

The arrangement of burners is not specifically limited, but the burners 16 are arranged as one row on the same line to have one burner array 17, for example, as shown in FIG. 4(a) Or the burners may be divided into a plurality of burner arrays, each burner directed toward the starting rod from different direction. As an example of arranging a plurality of burner arrays, a burner array 18 consisting of burners having greater flow rate of raw material and a burner array 19 having smaller flow rate of raw material are placed on different stages within the reaction vessel 4, as shown in FIG. 4(b). These burner arrays 18 and 19 are placed such that the burners make an angle θ with respect to the central axis of the soot body 9. With the arrangement between the burner arrays 18 and 19, the complex conduit is avoided when the burner-to-burner interval is narrow, the interference of flames is reduced when they are placed on the same line, and the soot deposition efficiency is increased. The angle θ is desirably in a range from 30° to 90°. At an angle below 30°, there is less effect, and at an angle beyond 90°, the exhaust efficiency is not enhanced.

Means for setting up the different synthesis conditions of glass particles for each burner is not specifically limited, but may be arbitrary means. A method for controlling the gas flow rate by a mass flow controller (MFC) without changing the structure of burners, a method for changing the structure itself of burners, or both, may be employed.

By the way, a method for forming the soot body having less fluctuation in the outer diameter on the starting rod employing a plurality of burners was disclosed in Japanese Patent Unexamined Publication No. Hei. 3-228845. With this method, since the glass rod and the burner arrays are reciprocated, the end portion of the soot body is considerably tapered, and becomes an ineffective portion. In this invention, the ineffective portion of taper shape is short and the glass material can be effectively used, because there is no reciprocating movement.

### EXAMPLES

This invention will be specifically described by way of examples, but is not limited to the given examples.

### Example 1

In an apparatus of the constitution as shown in FIG. 1, seven burners of the same type which consist of coaxial eight cyclic tubes are arranged at an interval of 60 mm in one row to constitute a burner array. Flow rate of gas supplied to the odd numbered burners or the even numbered burners are set up to be different each other and glass particles synthesized at each burner are deposited on the outer periphery of a rotating starting rod.

The raw material gas of SiCl₄ gas at four liters/min, hydrogen gas at 40 to 80 liters/min, oxygen gas at 70 liters/min, and seal argon gas at six liters/min were supplied to the odd numbered burners. The raw material gas of SiCl₄ gas at two liters/min, hydrogen gas at 25 to 50 liters/min, oxygen gas at 50 liters/min, and seal argon gas at six liters/min were supplied to the even numbered burners. The flow rate of hydrogen gas was gradually increased with the growth of soot body.

By use of the starting rod having a diameter of 20 mm and an effective portion length of 350 mm, soot was deposited on it to the outer diameter of 130 mm at maximum. The fluctuation ratio in the outer diameter of obtained soot body in the longitudinal direction was 3.0%, whereby the excellent soot body was produced.

The fluctuation ratio in the outer diameter is a value as indicated by the formula (2×100 (maximum diameter−minimum diameter)/(maximum diameter+minimum diameter))%.

### Example 2

In an apparatus of the constitution as shown in FIG. 1, the odd numbered burner is a burner which consists of eight concentric pipes and the even numbered burner is a burner which consists of four concentric pipes, whereby a total of seven burners are arranged at an interval of 50 mm in one row to constitute a burner array.

The raw material gas of SiCl₄ gas at 3.5 liters/min, hydrogen gas at 40 to 80 liters/min, oxygen gas at 70 liters/min, and seal argon gas at six liters/min were supplied to the odd numbered burners. The raw material gas of SiCl₄ gas at two liters/min, hydrogen gas at 20 to 40 liters/min, oxygen gas at 30 liters/min, and seal argon gas at six liters/min were supplied to the even numbered burners. The flow rate of hydrogen gas was gradually increased with the growth of soot body.

Glass particles synthesized by the burners were deposited as the soot around the outer circumference of a rotating starting rod. By use of the starting rod having a diameter of 20 mm and an effective portion length of 280 mm, the soot was deposited on it to the outer diameter of 120 mm at maximum. The fluctuation ratio in the outer diameter of obtained soot body in the longitudinal direction was 2.8%, whereby the excellent soot body was produced.

### Comparative Example 1

The soot body was produced under the same conditions as in the example 1, except that the amount of gas supplied to the even numbered burner was exactly equal to that supplied to the odd numbered burner. The fluctuation ratio in the outer diameter of obtained soot body in the longitudinal direction was as large as 8.0%, whereby the characteristics were unstable, and the soot body was defective.

### Example 3

Two arrays of burners were provided, and arranged at an angle θ of 60° as shown in FIG. 4(b). The odd numbered burners in the example were disposed in one row and the even numbered burners were disposed in the other row. Two arrays of burners were parallel, and the interval between the odd numbered burner and the even numbered burner was 60 mm in a direction of burner array, as shown in FIG. 4(c). The soot body was produced under the same other conditions as in the example 1. The fluctuation ratio in the outer diameter of soot body in the longitudinal direction was as large as 2.5%, whereby the excellent soot body was produced.

### Example 4

In an apparatus of the constitution as shown in FIG. 1, the odd numbered burners located at the odd number when counted from the top consist of three coaxial eight cyclic tube burners and the even numbered burners consist of three burners each of which consists of eight concentric pipes, whereby a total of six burners are arranged at an interval of 60 mm in one row to constitute a burner array.

The raw material gases, including SiCl₄ gas at four liters/min, hydrogen gas at 40 to 80 liters/min, oxygen gas at 70 liters/min, and seal argon gas at six liters/min were supplied to the odd numbered burners. The raw material gases, including SiCl₄ gas at two liters/min, hydrogen gas at 20 to 40 liters/min, oxygen gas at 30 liters/min, and seal argon gas at six liters/min were supplied to the even numbered burners. The flow rate of hydrogen gas was gradually increased with the growth of soot body.

Glass particles synthesized by the burners were deposited as the soot around the outer circumference of a rotating starting rod. By use of the starting rod having a diameter of 20 mm and an effective portion length of 250 mm, the soot was deposited on it to the outer diameter of 130 mm at maximum. The fluctuation ratio in the outer diameter of soot body in the longitudinal direction was 2.7%, whereby the excellent soot body was produced.

### Example 5

In an apparatus of the constitution as shown in FIG. 1, eight coaxial eight cyclic tube burners of the same type are arranged at an interval of 70 mm in one row to constitute a burner array.

The raw material gas of SiCl₄ gas at 1.5 liters/min, hydrogen gas at 20 to 40 liters/min, oxygen gas at 40 liters/min, and seal argon gas at six liters/min were supplied to the odd numbered burners, when counted from the top. The raw material gases of SiCl₄ gas at 3.5 liters/min, hydrogen gas at 50 to 80 liters/min, oxygen gas at 80 liters/min, and seal argon gas at six liters/min were supplied to the even numbered burners. The flow rate of hydrogen gas was gradually increased with the growth of soot body.

Glass particles synthesized by the burners were deposited as the soot around the outer circumference of a rotating starting rod. By use of the starting rod having a diameter of 30 mm and an effective portion length of 440 mm, the soot was deposited on it to the outer diameter of 200 mm at maximum. The fluctuation ratio in the outer diameter of soot body in the longitudinal direction was 2.9%, whereby the excellent soot body was produced.

### Example 6

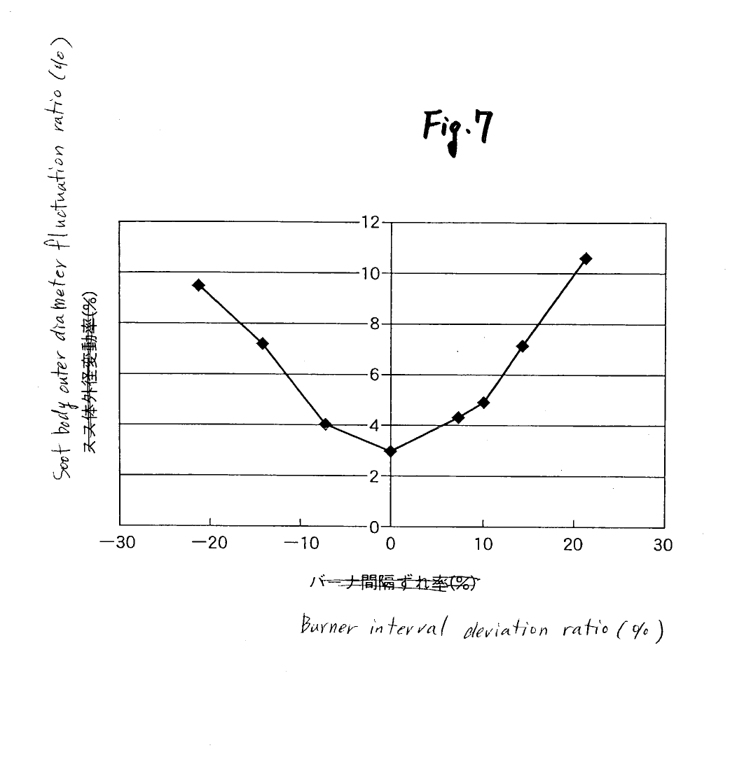

The interval between the burner at the lowermost end and the burner directly above it was changed, and other conditions were the same as in the example 5, whereby soot deposition was made. The fluctuation in the outer diameter of the soot body when the interval was changed is shown in FIG. 7. From the results as shown in FIG. 7, it was found that the fluctuation in the outer diameter of obtained soot body was within 5%, if a burner interval deviation from the set value of the interval falls from −8% to 10%, whereby the excellent soot body was produced. The deviation in plus direction is the case where the interval between burners is longer.

### INDUSTRIAL APPLICABILITY

As will be apparent from the above explanation, with the present invention, the glass particles deposit with less fluctuation in the outer diameter can be produced without increasing an unsteady portion of the outer diameter.

Also, with the producing apparatus for the glass particles deposit according to this invention, the above method can be easily enabled.

1. A method for producing a glass particles deposit in which a plurality of glass particle synthesizing burners are arranged to be opposed to a rotating starting rod, and glass particles synthesized by said glass particle synthesizing burners are deposited on a surface of the starting rod to produce the glass particles deposit, characterized in that:
three or more glass particle synthesizing burners are arranged in a state that each interval between burners is adjusted, and glass particle synthesis conditions for odd numbered burners located at the odd number when counted from one end of the burners, and those for even numbered burners located at the even number are set up differently, whereby glass particles are deposited on the surface of the starting rod to produce the glass particles deposit with less fluctuation in an outer diameter in a longitudinal direction.

2. The method for producing the glass particles deposit according to claim 1, characterized in that a total number of glass particle synthesizing burners is odd.

3. The method for producing the glass particles deposit according to claim 1 or 2, characterized in that an interval L between burners in a group of burners having a greater flow rate of raw material per burner, said group being selected from a group of burners located at the odd number when counted from one end and the group of burners located at the even number in said glass particle synthesizing burners, is set up to satisfy the following formula (1), and that the burners in a group of burners having a smaller flow rate of raw material per burner are arranged at an interval of L/2 to adjacent burners in the group of burners having greater flow rate of raw material per burner,
10a≦L≦A (1)
where L is an interval (mm) between burners in the group of burners having greater flow rate of raw material per burner, a is flow rate of raw material (liter/min) of a burner having greatest flow rate of raw material÷22.4 (liters/mole)×60 (g/mole), and A is the outer diameter (mm) of glass particles deposit of target.

4. The method for producing the glass particles deposit according to claim 3, characterized in that a deviation of the interval between burners from a set value is within a range from +10% to −10% of the set value.

5. The method for producing the glass particles deposit according to any one of claims 1 to 4, characterized in that the glass particle synthesis conditions for said glass particle synthesizing burners are set up so that an amount of gas supplied to each burner is alternately different.

6. The method for producing the glass particles deposit according to any one of claims 1 to 4, characterized in that the glass particle synthesis conditions for said glass particle synthesizing burners are set up so that a structure of each burner is alternately different.

7. An apparatus for producing a glass particles deposit in which a plurality of glass particle synthesizing burners are arranged to be opposed to a rotating starting rod, and glass particles synthesized by said glass particle synthesizing burners are deposited on a surface of the starting rod to produce the glass particles deposit, characterized in that:
the apparatus comprises three or more glass particle synthesizing burners in a state that each interval between burners is adjusted at a predetermined value, and a structure of odd numbered burners located at the odd number when counted from one end of the burners, and a structure of even numbered burners located at the even number are set up differently, thereby producing the glass particles deposit with less fluctuation in an outer diameter in a longitudinal direction.

8. The apparatus for producing the glass particles deposit according to claim 7, characterized in that a total number of three or more glass particle synthesizing burners is odd.

9. The apparatus for producing the glass particles deposit according to claim 7 or 8, characterized in that said burners is divided into two rows, when both rows of burners are seen as one array of burners from a direction perpendicular to the row of burners, burners located at the odd number when counted from one end are arranged in one row, and burners located at the even number are arranged in the other burner row.
